(19) United States
(12) Patent Application Publication
(10) Pub. No.: US 2016/0071140 A1
(43) Pub. Date: Mar. 10, 2016

(54) SYSTEMS AND METHODS FOR MANAGING LOYALTY REWARD PROGRAMS

(71) Applicant: EBAY INC., San Jose, CA (US)

(72) Inventor: Corinne Elizabeth Sherman, San Jose, CA (US)

(21) Appl. No.: 14/479,152

(22) Filed: Sep. 5, 2014

(51) Int. Cl. G06Q 30/02

(52) U.S. Cl. CPC G06Q 30/0226

(57) ABSTRACT

A system or a method is provided to manage a user's loyalty programs. In particular, the system may retrieve information from each of the user's loyalty programs to identify available loyalty programs for a given purchase. The system may infer or predict the user's future purchases. A comparison of different loyalty programs for a given purchase may be implemented in view of the user's future purchases. One or more loyalty programs that provide the user with good reward options based on the user's future purchases may be suggested to the user for certain purchases. In particular, loyalty programs that provide top reward values may be suggested to the user.

### BACKGROUND

1. Field of the Invention

The present invention generally relates to systems and methods for managing loyalty reward programs.

2. Related Art

Many merchants, such as grocery stores, airlines, payment card providers, or the like, offer loyalty reward programs to consumers. These reward programs entice consumers to continue shopping at the merchants or utilizing the merchants services. Different loyalty reward programs provide different rewards, such as cash backs, rebates, discounts, free travel amenities, free airplane tickets, or various redeemable items. Different loyalty reward programs also provide different ways to earn the rewards, such as by accumulating points, travel mileage, and the like. A consumer may sign up or participate in a plurality of different loyalty reward programs. It may be difficult for the consumer to keep track of the different loyalty reward programs. Further, it may be difficult for the consumer to determine which loyalty reward program to utilize when making a purchase. Therefore, there is a need for a system or method that helps manage the different loyalty reward programs of a consumer.

### BRIEF DESCRIPTION OF THE FIGURES

FIG. 1 is a block diagram of a networked system suitable for implementing loyalty program management.

FIG. 2 is a flowchart showing a process of setting up a user account for loyalty program management according to an embodiment.

FIG. 3 is a flowchart showing a process for managing loyalty programs according to one embodiment.

FIG. 4 is a block diagram of a computer system suitable for implementing one or more components in FIG. 1 according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to an embodiment, a system or a method is provided to manage a user's loyalty programs. In particular, the system may retrieve information from each of the user's loyalty programs to identify available loyalty programs for a given purchase. A comparison of different loyalty programs for a given purchase may also be implemented. Based, at least in part, on a projected value of various loyalty programs to the user, one or more loyalty programs may be suggested to the user for certain purchases. In particular, loyalty programs that provide top reward values, currently and in the future, may be suggested to the user.

In an embodiment, the system may suggest a merchant and an applicable loyalty program when the user is searching for or wanting to purchase a particular item. For example, the user may wish to purchase a TV. Store A may have the best price, but the system may forecast that the user will make many future purchases at Store B. For example, the user may have just bought a house and Store B is a home improvement store. Thus, even if store B has a higher price for the TV, the system may suggest Store B over Store A, such that the user may earn more reward points at the loyalty program at Store B in view of the user's future purchases at Store B.

In an embodiment, the system may calculate a reward value to expense ratio for each loyalty program and may compare the reward value to expense ratio of different loyalty programs. The system may suggest loyalty programs that provide top reward value per dollar spent to the user in view of the user's projected future purchases.

In an embodiment, the system may review the point or mileage accumulation of each loyalty program and may compare the accumulations of the loyalty programs. The system may suggest loyalty programs that have accumulated almost enough points or mileage for earning rewards. Thus, loyalty programs that are closer to earning rewards may be suggested to the user to earn rewards faster.

In an embodiment, the system may analyze the user's purchase history, search history, watch list, wish list, or the like to determine the user's purchase pattern or routine. Based on the user's purchase pattern or routine, the system may select loyalty programs that provide better reward values for the user. The system may suggest loyalty programs from the user's existing loyalty programs or may suggest a new loyalty program for the user to sign up. For example, the system may analyze the user's purchase history of the past year and may determine the user's expenses in different categories, such as travel, restaurant, grocery, gasoline, and the like. The system may suggest loyalty programs that provide better reward values based on the user's projected future expenses in the different categories of purchase.

In an embodiment, the system may analyze the user's to-do-list, search history, watch list, wish list, calendar, or the like to forecast purchases the user will make. Based on the purchase forecast, the system may suggest loyalty programs that provide better reward values for the user's future purchases. For example, the system may analyze the user's search history and calendar and may determine that the user is about to make travel arrangements for a trip. Thus, the system may suggest loyalty programs that provide better reward values for travel related purchases.

In an embodiment, the system may allow the user to identify or set up reward preferences or reward goals which the user wishes to earn. The system may analyze the user's reward goals and may suggest loyalty programs that provide better value or a faster way to reach the user's reward goals. For example, the user may answer a questionnaire or a survey on the user's reward preferences and goals, and the system may analyze the user's input to suggest loyalty programs based on the user's reward preferences and goals.

In an embodiment, the system may analyze the user's credit history and credit scores and may suggest loyalty programs or payment card providers that improve the user's credit score. For example, based on the user's purchase habits or patterns, the system may determine a combination of different loyalty programs or payment card services for the user to enroll that may improve the user's overall credit score. In another example, keeping consistent credit at certain reputable credit card accounts may improve the user's overall credit score. In still another example, the system may recommend the user to pay off and cancel certain credit card accounts to improve the user's overall credit score.

In an embodiment, the system may monitor activities and accumulations of the user's various loyalty programs. Based on different policies and rules of various loyalty programs, different reward points or reward mileages may have different expiration dates. The system may keep track of different expiration dates of various reward points or reward mileages and may notify the user if certain reward points or reward mileages are about to expire. The system may suggest alternatives for the user to redeem the reward points or reward mileages that are about to expire.

In an embodiment, the system may allow merchants to compete for the user's loyalty based on the user's reward preferences. For example, a credit card company may provide a customized loyalty program based on the user's reward preferences and projected future purchases. Thus, based on the user's reward preferences, merchants may better compete for the user's loyalty and business.

In an embodiment, the system may consider and suggest loyalty programs or merchants with loyalty programs that may allow user to earn reward points or miles based on non-purchase activities. For example, a user may earn reward points or miles by sharing a link or liking a merchant online or on social networking accounts. Based on the user's reward earning activities and routines, the system may consider and suggest loyalty programs or merchants to the user.

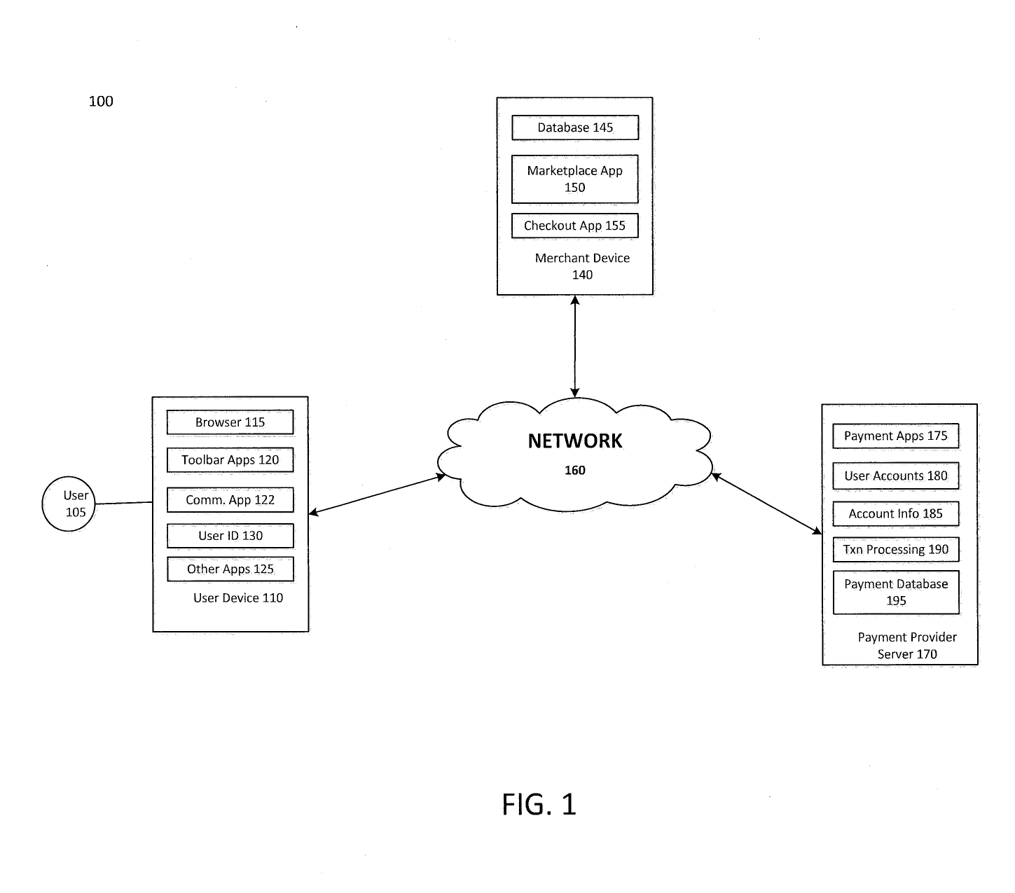

FIG. 1 is a block diagram of a networked system 100 suitable for implementing shopping detours during traffic congestions according to an embodiment. Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a user device 110, a merchant server 140, and a payment provider server 170 in communication over a network 160. Payment provider server 170 may be maintained by a payment service provider, such as PayPal, Inc. of San Jose, Calif. A user 105, such as a sender or consumer, utilizes user device 110 to perform a transaction using payment provider server 170. User 105 may utilize user device 110 to initiate a payment transaction, receive a transaction approval request, or reply to the request. Note that transaction, as used herein, refers to any suitable action performed using the user device, including payments, transfer of information, display of information, etc. For example, user 105 may utilize user device 110 to initiate a deposit into a savings account. Although only one merchant server is shown, a plurality of merchant servers may be utilized if the user is purchasing products or services from multiple merchants.

User device 110, merchant server 140, and payment provider server 170 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160. Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, user device 110 may be implemented as a personal computer (PC), a smart phone, wearable device, laptop computer, automobile console, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for setting up a shopping list and/or merchant sites for viewing and purchasing products and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 may further include other applications 125 as may be desired in particular embodiments to provide desired features to user device 110. For example, other applications 125 may include security applications for implementing client-side security features, programmatic client applications for interfacing with appropriate application programming interfaces (APIs) over network 160, or other types of applications. User device 110 also may include a positioning device, such as a Global Positioning System (GPS), a gyroscope, or other devices configured to detect a position and movement of the user device 110.

Applications 125 may also include email, texting, voice and IM applications that allow user 105 to send and receive emails, calls, and texts through network 160, as well as applications that enable the user to communicate, transfer information, make payments, and otherwise utilize services of the payment provider as discussed herein. User device 110 includes one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100.

Merchant server 140 may be maintained, for example, by a merchant or seller offering various products and/or services. The merchant may have a physical point-of-sale (POS) store front. The merchant may be a participating merchant who has a merchant account with the payment service provider. Merchant server 140 may be used for POS or online purchases and transactions. Generally, merchant server 140 may be maintained by anyone or any entity that receives money, which includes charities as well as banks and retailers. For example, a payment may be a donation to charity or a deposit to a saving account. Merchant server 140 may include a database 145 identifying available products (including digital goods) and/or services (e.g., collectively referred to as items) which may be made available for viewing and purchase by user 105. Accordingly, merchant server 140 also may include a marketplace application 150 which may be configured to serve information over network 160 to browser 115 of user device 110. In one embodiment, user 105 may interact with marketplace application 150 through browser applications over network 160 in order to view various products, food items, or services identified in database 145.

Merchant server 140 also may include a checkout application 155 which may be configured to facilitate the purchase by user 105 of goods or services online or at a physical POS or store front. Checkout application 155 may be configured to accept payment information from or on behalf of user 105 through payment service provider server 170 over network 160. For example, checkout application 155 may receive and process a payment confirmation from payment service provider server 170, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like.

Merchant server 140 may include a database that stores loyalty accounts of various users or customers. The database may store information regarding various loyalty programs offered by the merchant including policies and rules of the loyalty programs. The loyalty accounts may store information regarding the loyalty accounts of each user. The loyalty account may include reward policies and rules for the loyalty account, loyalty points or mileage accumulated by a user, reward items available, expiration dates of loyalty points or mileage, reward activity history, and other information regarding a user's loyalty account. Thus, the merchant may keep track of each user or customer's purchase or reward activities by these loyalty accounts. The merchant may also facilitate redemption of rewards to the user via these loyalty accounts.

Payment provider server 170 may be maintained, for example, by an online payment service provider which may provide payment between user 105 and the operator of merchant server 140. In this regard, payment provider server 170 includes one or more payment applications 175 which may be configured to interact with user device 110 and/or merchant server 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as banks or credit card companies. For example, account information 185 may include private financial information of users of devices such as account numbers, passwords, device identifiers, user names, phone numbers, credit card information, bank information, or other financial information which may be used to facilitate online transactions by user 105. Advantageously, payment application 175 may be configured to interact with merchant server 140 on behalf of user 105 during a transaction with checkout application 155 to track and manage purchases made by users and which and when funding sources are used.

In some embodiments, payment provider server 170 may store purchase history of various items purchased by user 105. Payment provider server 170 may analyze purchase history to determine user 105's purchase preferences, merchant preferences, and/or purchase forecasts. Payment provider server 170 also may have access to user 105's calendar, schedule, to-do list, emails, social network accounts, loyalty accounts and the like. Payment provider server 170 may analyze these accounts to infer purchase preferences or purchase targets. Payment provider server 170 may store or associate a plurality of loyalty accounts enrolled by a user with the user's account at the payment service provider. Payment provider server 170 may have access to these loyalty accounts of the user 105 and may receive loyalty account information, such as account policies and rules, reward policies and rules, current reward points or mileages accumulated by the user, and the like. Thus, payment provider server 170 may help the user 105 manage a plurality of different loyalty programs enrolled by the user 105. In particular, payment provider server 170 may analyze and suggest loyalty programs that provide the user 105 with better reward values, especially for future purchases.

A transaction processing application 190, which may be part of payment application 175 or separate, may be configured to receive information from user device 110 and/or merchant server 140 for processing and storage in a payment database 195. Transaction processing application 190 may include one or more applications to process information from user 105 for processing an order and payment using various selected funding instruments, including for initial purchase and payment after purchase as described herein. As such, transaction processing application 190 may store details of an order from individual users, including funding source used, credit options available, etc. Payment application 175 may be further configured to determine the existence of and to manage accounts for user 105, as well as create new accounts if necessary.

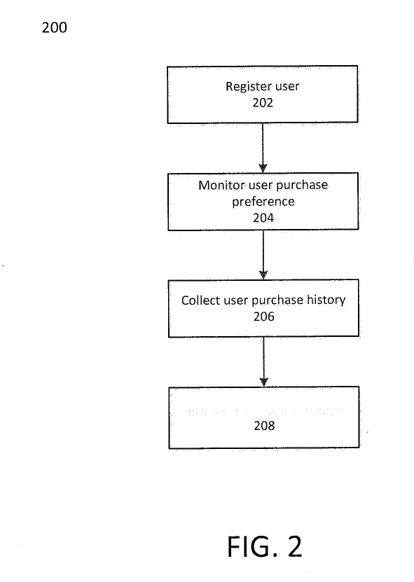

FIG. 2 is a flowchart showing a process 200 for setting up a user account for loyalty program management according to an embodiment. At step 202, a user may register at payment provider server 170. For example, a user may set up a payment account at payment provider server 170 using user device 140. The payment account may be used for making payments for purchases made by the user. The payment account may include user information, such as user identification, password, user preferences, funding accounts, and the like. The user 105 also may identify and input loyalty programs the user 105 has enrolled in. For example, the user 105 may identify loyalty programs at different merchants, credit card accounts issued from different credit card service providers, loyalty accounts at various airlines, or any other accounts that allow the user 105 to accumulate reward points or mileage to earn rewards. The user 105 may provide user name, login ID, and/or password for these loyalty accounts and may allow payment provider server 170 access to these loyalty accounts.

At step 204, payment provider server 170 may monitor user purchase preferences. For example, when user 105 uses user device 140 to search or browse various products or services, payment provider server 170 may forecast possible future purchases based on user 105's browsing or search history. For example, user 105 may have been searching or browsing various airplane tickets using user device 140, the browsing and searching history related to the flight search may be sent to payment provider server 170.

In one embodiment, user 105 may give permission to payment provider server 170 to access the browsing or search history at user device 140. Payment provider server 170 may analyze the browsing history and search history and determine that user 105 is looking to purchase a flight ticket from home to a destination. Thus, various travel related purchases may be included in the purchase forecast.

User 105's purchase history also may be used to determine the user's purchase preferences or future purchases. For example, the type of products or services that had been purchased by user 105, the merchants from which user 105 had made purchases, or the time and location where user 105 made purchases may be monitored and stored as a user purchase preferences. In another example, payment provider server 170 may determine routine purchases, such as groceries, daily necessities, or the like, that are purchased by the user 105 routinely.

Payment provider server 170 may determine the purchase routine frequency and may forecast that the user 105 likely is ready to make the routine purchase again soon. For example, the payment provider server 170 may determine that the user 105 typically purchases milk once a week on Friday. The payment provider server 170 may then forecast that the user 105 may wish to purchase milk this Friday.

In an embodiment, user 105 may give permission to payment provider server 170 to access user 105's calendar, to-do list, schedule, wish list, social network accounts, contact lists, travel history, and the like. The payment provider server 170 may analyze this information and may determine purchase preference and/or purchase forecasts from this information. For example, based on the user 105's to-do list and social network, the payment provider server 170 may determine that the user 105 is planning on traveling to a friend's wedding in another state. Thus, the payment provider server 170 may forecast that the user 105 will make various travel-related purchases, such as plane tickets, rental cars, and hotels, for this wedding trip.

At step 206, payment provider server 170 may collect user purchase history. For example, when user 105 uses user device 140 or an account with the payment provider to make a purchase, payment provider server 170 may collect information related to the purchase, including the identity and type of items purchased, price of the item purchased, location and time of purchase, merchant from whom the purchase was made, or other information related to the purchase. In an embodiment, payment provider server 170 may have access to user 105's loyalty accounts at various merchants and may determine user 105's purchase and/or browsing history at the merchants based on the user 105's loyalty account at these merchants. Payment provider server 170 also may access the user 105's electronic wallet and electronic coupons. For example, the user 105 may save or designate certain electronic coupons to be used later. Payment provider server 170 may determine purchase preferences or purchase forecasts based on these saved electronic coupons.

In an example, payment provider server 170 may analyze the user 105's expense history for the last fiscal year and may determine the user 105's purchases made in different expense categories. For example, for the last fiscal year, the user 105 may have spent $3,000 on travel, $2,000 on restaurants, $5,000 on grocery, etc. The payment provider server 170 may use this purchase history to forecast or budget expenses for the next fiscal year and beyond and may suggest loyalty programs that provide better reward values based on the expense pattern and forecasted future purchases.

At step 218, payment provider server 170 may infer or forecast the user 105's future purchases based on various information collected, as noted above. The purchase forecasts may be inferred from purchase history or routine purchases. For example, based on monthly purchase history, the payment provider server 170 may determine that the user 105 typically spends about $300 on restaurants a month. Thus, the payment provider server 170 may forecast that the user 105 will spend about $300 each month on restaurants.

The purchase forecasts may be inferred from the user 105's wish list, to-do list, calendar, and/or social network. For example, the user 105 may have a task of renting a car for a business trip in the to-do list and the calendar of the user 105 also have a business meeting at a different city. Thus, the payment provider server 170 may determine that the user 105 is planning a business trip to a different city and may forecast business trip related expenses around the date of the business meeting.

In an embodiment, the payment service provider 170 may calculate a probability score for a purchase forecast. The probability score may represent a likelihood that the purchase forecast is correct. The probability score may be determined based on whether the purchase forecast is related to a routine purchase. For example, if an item is consistently purchased many times as a regular routine, the probability score is higher. The probability score also may be determined based on the number sources the purchase forecast is inferred from. For example, if the purchase forecast is inferred from multiple sources, such as from the user 105's social network, the user's calendar, and the user's to-do list, the probability score may be higher.

The probability score also may be determined based on the type of sources the purchase forecast is inferred from. For example, a purchase forecast based on the user 105's to-do list may have a higher probability score than another purchase forecast based on the user 105's watch list, because the user 105's to-do list indicates that the user 105 has decided to make the purchase while the user 105's watch list merely indicates that the user is interested in an item. When the probability score of a purchase forecast is above a predetermined threshold, the purchase forecast may be used to make loyalty program suggestions. The predetermined threshold may be adjusted to increase or decrease the number of purchase forecasts.

By using the above process 200, various information may be collected to determine the user 105's purchase preferences and forecast possible further purchases. In particular, information, such as purchase history, browsing history, to-do list, wish list, customer accounts, calendar, social network accounts, and the like, may be analyzed to determine purchase preferences and to forecast future purchases. The purchase preferences and purchase forecasts may be used to suggest loyalty programs that provide better reward values for the user 105.

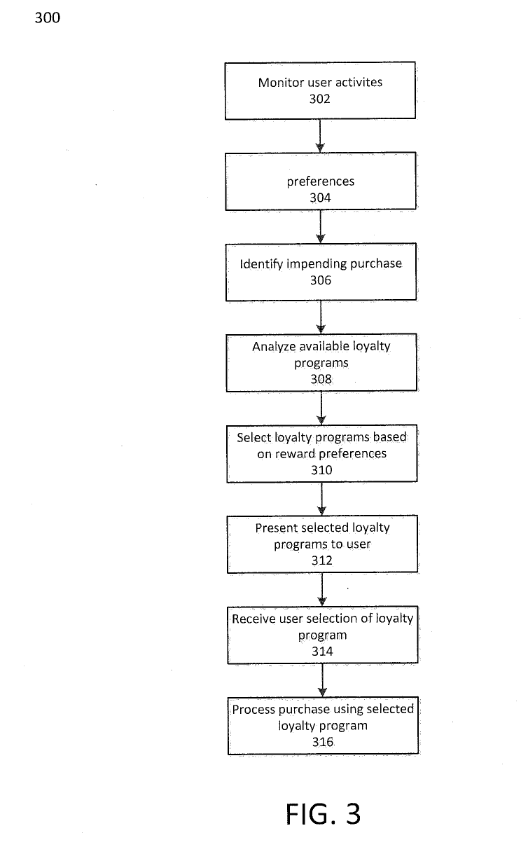

FIG. 3 is a flowchart showing a process 300 for implementing management of loyalty programs according to one embodiment. At step 302, user device 110 may monitor user activities. User device 110 may monitor user 105's operations on user device 110 including user 105's browsing and purchasing activities. User 105's activities also may include the application the user 105 is using, the merchant website the user 105 is viewing or browsing, the type of products or services the user 105 is searching or browsing, communication between the user 105 and other users, such as emails, text messages, and the like. User 105's activities also may include user 105's input on calendar applications, scheduling applications, merchant applications, and the like. User device 110 may include a Global Positioning System (GPS) device configured to detect the position and movement of user device 110. Thus, the user 105's position and movement may be monitored as user 105's activities. The system also may monitor the user 105's environment, such as temperature, humidity, altitude, weather, weather forecast, travel speed, and the like. All this information may be communicated to and analyzed by a service provider to determine whether to suggest loyalty programs to the user 105 and which loyalty programs should be suggested to the user 105.

At step 304, the system may determine the user 105's reward preferences. In an embodiment, the system may allow the user 105 to input reward preferences desired by the user 105. In particular, the user 105 may select one or more categories or types of rewards the user 105 prefers, such as cash back rewards, travel rewards, discounts at certain merchants, dining rewards, certain service or product rewards, and the like. Travel rewards may include plane tickets, rental cars, lodgings, vacation packages, cruises, travel amenities, such as free bag check ins for flights, priority boarding at airports, VIP lounges, VIP services, travel insurance, flight seat upgrades, and the like. In an embodiment, the reward may be a donation to a particular charity. The user 105 may identify and/or select from a plurality of different types of rewards.

In an embodiment, the user 105 may rank their reward preferences in a priority order. For example, the user 105 may prefer to earn travel related rewards first and then would like to earn cash rebates secondly. In another example, the user 105 may identify certain products or services, such as a television, a vacation, or tickets to amusement parks, as reward preferences. In another embodiment, the user 105 may prefer loyalty programs that provide rewards with the actual monetary value, e.g., cash value. For example, the user 105 may prefer loyalty programs that offer rewards that have the best market values.

In an embodiment, the user 105 may prefer rewards that can be earned faster. As such, the user 105 does not have to wait for a long time to receive the rewards. In another embodiment, the user 105 may prefer rewards that have good liquidity or can be exchanged easily. For example, cash rewards have good liquidity. In another example, certain loyalty programs form an alliance and may allow users to exchange points or mileage among these different loyalty programs.

In an embodiment, the user 105's reward preferences or future purchases may be inferred from the user's purchase history or browsing history. For example, based on the user's expense history, the system may determine that the user 105 makes a substantial amount of purchases from a certain merchant and may benefit from receiving rewards that provide discounts at the certain merchant. In another example, based on the user's travel history, the system may determine that the user 105 travels substantially by airplane and may benefit from receiving rewards related to flights, including free or discounted airfare or other travel amenities, such as free bag check-in, airport VIP lounges, and the like.

At step 306, the system may identify impending purchases based on user 105's activities. In response to identifying the impending purchase, the system may prepare to present recommendations or suggestions for loyalty programs to the user 105. Impending purchases may be identified or detected based on user 105's online activities, such as web browsing activities, search activities, online shopping carts, and the like. In an embodiment, the system may determine that the user 105 is shopping for a certain product or service online and may identify the product or service as impending purchase. Impending purchase may be identified from the user 105's search terms, website visited, merchant visited, items placed on the shopping carts, check-out page, and the like.

In an embodiment, the system may detect via user device 110's GPS device the location and movement of the user 105. Impending purchases may be identified or detected based on user 105's location and/or movements. For example, the system may determine that the user 105 is in a merchant's store, at a restaurant, at a barber shop, at an auto-mechanic shop, at a shopping mall, at an airport, or at any place where possible specific purchases may be made. The system may then determine an impending purchase of a product associated with that location. In some embodiment, the user device 110 may include Bluetooth communication device or Near-Field Communication (NFC) device that may be used to detect the location and/or movement of the user device 110 within a merchant's store. As such, when the user 105 is detected near a check-out counter, the system may determine that the user is about to make a purchase.

In an embodiment, the system may detect download and/or activation of certain applications on user device 110 to determine an impending purchase. For example, the user 105 may activate certain shopping applications downloaded from a merchant. The system may then determine that the user 105 is about to shop and/or make purchase at the merchant using the shopping application. In another example, the system may detect impending purchases based on items placed on the user 105's wish list at a merchant's website or in a merchant's shopping application. In still another example, the system may detect impending purchases based on electronic coupons or incentives collected or saved by the user 105.

In an embodiment, the system may detect impending purchases based on the user 105's communication with others and/or based on the user 105's social network accounts. For example, the system may analyze the user 105's emails, text messages, chatting session, social network postings, and the like and may determine the user 105 has been discussing certain products or services with others. In still another embodiment, the system may analyze the user 105's to-do list, calendar, schedule, or the like to determine impending purchases. For example, based on the user 105's travel plan, appointments scheduled at certain locations, business tasks, and the like, the system may determine the time and date when the user 105 may plan to make certain purchases.

In an embodiment, the system may allow the user 105 to identify or input products or services that the user 105 wishes to or plans to purchase and when the user 105 plans to or intends to make such a purchase. For example, the user 105 may answer a survey or a questionnaire and may indicate big purchases or travel plans the user 105 plans to make for a fiscal year. In another example, the user 105 may have a budget for purchases or expenses that the user 105 plans to make for a specific month or year. The system may determine impending purchase based on the budget for the next month or the next year.

In an embodiment, the system may determine impending purchases based on routine purchases or the user 105's purchase habits. For example, based on the user's purchase history, the system may determine that the user 105 routinely purchases a plane ticket to visit family during holiday seasons. Thus, the system may determine that the user 105 likely will purchase a plane ticket with the approaching holiday season.

By determining and/or identifying impending purchases, the system may provide recommendations or suggestions regarding which loyalty programs to use for the impending purchase. For example, when the system detects that the user 105 is about to make a purchase at a merchant's store, the system may present recommendations or suggestions on which loyalty program to use for that purchase. In another example, when the system detects that the user 105 is planning on a big purchase, such as a car or plane tickets, the system may suggest loyalty programs to the user 105 to provide better reward values for the big purchase.

In response to detecting the impending purchases, the system may identify merchants that offer the impending purchases for sale and analyze loyalty programs that are applicable to the identified merchants at step 308. In particular, the system may search and find nearby merchants that offer the product or services desired by the user and may review the plurality of loyalty programs that are applicable to the merchants and the impending purchase. Applicable loyalty programs are the ones that can be used at the respective merchants to earn rewards. One or more loyalty programs may be used during a purchase to earn rewards. For example, when the user 105 is about to make a purchase at a grocery store, the system may identify several credit cards with respective loyalty programs that can be used to pay for the impending purchase. The system also may identify the user 105's loyalty reward account at the merchant that may be used to obtain rewards or discounts at the merchant.

In an embodiment, the system may search and identify merchants where the user 105 may make the impending purchase. The system may compare the prices at these merchants. Further, the system may compare the loyalty programs of these merchants in view of the user 105's purchase forecast or future purchases. The reward values of the loyalty programs at these merchants may be evaluated in view of the prices of the impending purchase and the user's future purchases. For example, merchant A may offer a lower price for the impending purchase than that of merchant B. However, the system may forecast that the user will make more future purchases at merchant B. Thus, in view of the user's future forecasts, the loyalty program at merchant B may offer better reward values that outweigh the difference in the prices of the impending purchase. In this case, the system may suggest merchant B and the associated loyalty program to the user.

In an embodiment, the system may have a database of various loyalty programs offered by various merchants, payment service providers, airlines, lodging services, and the like. The system may analyze the database in view of the impending purchases and may identify loyalty programs that may be applicable to the impending purchases and that have not been enrolled by the user 105. Thus, the system may suggest new loyalty programs to the user 105. In another embodiment, information about the user's reward preferences and/or purchase habits or patterns may be provided to a merchant with the user's permission. The merchant then may generate a new loyalty program that is tailored to the user's reward preferences or purchase habits to provide the user with top reward values.

The system may analyze these applicable loyalty programs in view of the impending purchases and the purchase forecast of the user. In particular, the system may access user 105's accounts at these applicable loyalty programs and may determine the user 105's reward status, such as reward point accumulated and/or reward miles accumulated. The system also may analyze the rules and policies the loyalty programs to determine the rewards that are available and how close the user is to the next reward. Other restrictions or rules of the loyalty programs also may be considered. For example, two or more loyalty programs may be used for the same purchase or certain purchases or purchases of certain products or services are restricted from earning reward points.

At step 310, the system may select loyalty programs based on reward preferences and the purchase forecast of the user. In particular, the system may select loyalty programs based on reward preferences defined by the user 105 and purchase forecast inferred from the user 105's purchase history. For example, the user 105 may have a reward preference for cash backs. Thus, the system may select loyalty programs that provide the best percentage of cash backs for the impending purchase. In another example, the user 105 may have a reward goal of a certain product offered at a certain merchant. The system may identify the loyalty program that offers the product as a reward and may suggest this loyalty program to the user 105. In still another example, the purchase forecast of the user 105 may indicate that the user 105 likely will make many future purchases at a certain merchant. Thus, the system may identify and select a loyalty program associated with the certain merchant.

In an embodiment, the system may determine the market value of the reward product, such as the cost of purchasing the product including tax, and/or shipping cost for the product. The system may also identify loyalty programs that offer cash backs. The system may compare the loyalty program that offers the reward product as a reward and the loyalty program that offers cash backs and may determine which of these loyalty programs provide reward points that can get the user 105 to earn the reward product faster. For example, the first loyalty program may require 50,000 reward points to earn the reward product. The system also may determine that the reward product has a market price of $400. As such, the user 105 may purchase the reward product from an online marketplace for $400 plus $10 tax and shipping ($410 total). The second loyalty program may require 41,000 reward points to get the $410 cash back. Thus, assuming that each reward point is earned by one dollar spent in both loyalty programs, the second loyalty program may be suggested to the user, because the user 105 may reach the reward goal faster using the second loyalty program in view of the cost of the reward product. In another embodiment, the system may select loyalty programs based on purchase forecasts inferred from the user 105's budget or the user 105's recent browsing history, search history, or purchase history. As noted above, in steps 202-208, impending or future purchases may be inferred or forecasted from the user 105's activities and/or expense budges. Based on the user 105's spending trend, one or more loyalty programs may be selected and suggested to the user 105 to provide the user 105 with better reward values. For example, the user 105's purchase forecast may estimate $5,000 on travel related purchases, $1,500 on dinning purchases, and $3,000 on grocery purchases. In view of the estimated expense amounts in different expense categories, the system may suggest one or more loyalty programs that tailored to the expense forecast to provide the user 105 with better reward values. For example, the system may suggest a loyalty program that gives the most percentage cash back on travel related purchases, the second most percentage cash back on grocery purchases, and the third most percentage cash back on dining purchases.

In still another embodiment, by default, the system may select loyalty programs based on the monetary value of rewards offered by the loyalty programs. In particular, the system may calculate an estimated total reward value based on the purchase forecasts. Using the above example, if a loyalty program gives 3% cash back on travel related purchases, 2% on grocery purchases, and 1% on dining purchases, the estimated total reward value is $5,000×3%+$3,000×2%+$1,500×1%=$225. The system may estimate the total reward values of various loyalty programs in view of the user 105's purchase forecast and may compare their total reward values. As such, the system may select one or more loyalty programs that provide top estimated total reward values.

Some loyalty programs may provide additional amenities or perks besides cash back, such as reward products or services, travel amenities, such as airport lounges, free first checked bag, free drinks on the airplane, or rental car insurance. The system may estimate the market value of these products, services, or amenities in order to compare them across different loyalty programs. For example, a bag check typically may cost $40. Thus, the system may estimate the value of a free bag check is $40. By converting these reward products, services, or amenities in to monetary values, the system may better compare them across different loyalty programs.

Some loyalty programs may provide discounts or coupons at certain merchants or for certain categories of purchases. These discounts or coupons also may be converted into monetary values for comparison. In particular, the values of the discounts or coupons may be estimated based on the budget or purchase history of the user 105. For example, a loyalty program may offer a 20% discount at a merchant. Based on the user 105's purchase history or budget, the system may estimate how much money the user 105 will spend at the merchant. Thus, the value of the 20% discount may be estimated. For example, the system may estimate that the user will spend $500 at the merchant next year. Thus, the value of the 20% discount is $100 for the next year. Some loyalty programs may require membership fees. The system may take these membership fees into consideration for determining the total reward values of the loyalty programs.

Accordingly, by converting various rewards into monetary values and using the user's purchase forecast, the system may estimate the total monetary reward values of various loyalty programs and may compare them to select one or more loyalty programs that provide top reward values for the user 105.

In an embodiment, the system may select loyalty programs that provide top reward value to expense ratios. In particular, a reward value per dollar spent may be calculated based on the market values of rewards, the reward points or mileages needed to redeem the rewards, and the dollar amount needed to earn a reward point or mileage. For example, a loyalty reward program may offer a cash reward of $100 redeemable with 15,000 reward points and each reward point is earned by spending one dollar. Thus, the reward value to expense ratio of the loyalty reward program is $100/15,000=$0.0067 of reward value per dollar spent. In another example, a loyalty program may offer a reward vacation package redeemable with 50,000 mileage points. The system may estimate that the reward vacation package has a market value of about $500. Further, the system may estimate that it costs about $10,000 worth of plane tickets to travel 50,000 air miles. Thus, the reward value to expense ratio is $500/$10,000=$0.05 reward value per dollar spent. The system may calculate or estimate the reward value to expense ratio of each loyalty program. The system may compare and select loyalty programs that provide top reward values per dollar spent and may suggest them to the user 105.

In an embodiment, the system may calculate the reward value to expense ratio based on the user's purchase forecast. For example, the system may estimate the market values of rewards earnable by the user's future purchases. The system may also estimate the expenses of the user's future purchases at different merchants based on the different prices offered at these merchants. Thus, reward value to expense ratio may be estimated or calculated based on the user's projected future purchases.

In an embodiment, the system may select reward loyalty programs that provide substantial or extraordinary savings for particular purchases. In particular, the user 105 may indicate that the user 105 is planning on making a one-time big purchase, such as a television, a home improvement project, a car, or the like. These one-time big purchases may not be inferred from the user 105's purchase history. In an embodiment these one-time big purchases may be inferred from the user 105's recent search history, browsing history, to-do list, wish list, watch list, or the like. The system may search and identify loyalty programs that may provide substantial reward or savings for these one-time purchases. In some embodiments, the system may search and identify new loyalty programs for the user 105 to sign up to provide the user 105 with better reward values for these one-time purchases.

For example, the user 105 may plan to purchase a car this coming month. The system may identify loyalty programs that may provide special discounts, special financing, or cash back. The system may compare the relative values of these different loyalty programs and may select loyalty programs that provide top reward values for the user 105. In an embodiment, the system may recommend a first default loyalty program for the user 105's general purchases, but may recommend a second loyalty program for the one-time purchase, because the second loyalty program offers substantial reward values for the one-time purchase.

Different merchants or payment services may offer different rewards or discounts during different seasons. Thus, the system may continuously update the database that stores information of various loyalty programs to reflect the most updated reward programs or discounts. In an embodiment, seasonal special offers or discounts may be offered to the user 105 via loyalty programs. Based on the impending purchase, the system may determine that the user 105 may earn a limited time reward via a new loyalty program. The limited time reward may provide substantial reward value per dollar spent that substantially outweighs the reward values provided by the user 105's default loyalty program or the user 105's reward preferences. Thus, the system may suggest that the user 105 sign up and/or utilize this new loyalty program to earn this limited time reward.

In an embodiment, the system may select loyalty programs that are closest to earning a reward for the user 105. In particular, the system may look up how many reward points or reward miles the user 105 has accumulated in each loyalty program. The system may calculate the difference between the current number of reward points or miles and the number of reward points or miles needed to earn a reward. The system may select loyalty programs that are closest to earning a reward. For example, the user 105 may have 4300 reward points in loyalty program A, which requires 5000 reward points to earn a reward. The user 105 may have 300 reward miles in loyalty program B, which required 2000 reward miles to earn a reward. The system may then select loyalty program A, because it has less difference between the current reward points and the total reward points needed to earn a reward.

In an embodiment, the system may monitor the user 105's credit status or credit score and may recommend loyalty programs that may help increase the user 105's credit score. For example, the user 105 may have several credit card accounts with respective loyalty programs. Based on the user 105's credit score, the system may recommend the user 105 to pay off and close certain credit card accounts and open certain new credit card accounts to boost the user 105's credit score. In an embodiment, the user 105's credit score also may be used to determine whether the user 105 is qualified for certain credit card services with respective loyalty programs. The system may select loyalty programs from credit card services that the user 105 is qualified for based on the user 105's credit score and credit status.

In an embodiment, the system may review the reward points or miles of different loyalty programs and may determine that certain reward points or miles are about to expire. As such, the system may assess whether the reward points or miles may be used before they expire and how the user 105 should try to earn more reward points or miles in that loyalty program to earn a reward before the reward points or miles are expired. Thus, the system may select the loyalty programs to attempt to earn a reward before the reward points or miles expire.

In an embodiment, the system may consider non-purchase activities that may earn reward points or miles for certain loyalty programs. For example, some loyalty programs may allow users to earn reward points or miles by clicking on a link, forwarding a link or a message, sharing a link on a social networking account, watching a promotional video, referring a friend, and the like. The system may consider the possibility that user 105 is likely to perform various non-purchase activities that may earn reward points and miles and may suggest merchants or loyalty programs that earn the most reward points or miles based on the user 105's likelihood of performing these non-purchase activities. For example, the user 105 may frequently use certain social networking account where reward points may be earned by sharing or linking certain promotional material. As such, the system may suggest a merchant or a loyalty program that allows the user to earn reward points by sharing or linking promotional materials in the social networking account. In another example, if the user desires to purchase a certain product and other friends of the user also desire to purchase the same product, the system may suggest a loyalty program that provides discounts or additional reward points for purchasing the product in a group, such as Groupon. As such, if the user and the other friends all purchase the same product using the loyalty program, the user and the other friend may earn discounts or additional reward points.

In still another example, certain loyalty programs allow users to earn reward points by visiting or checking in at certain merchant locations, by viewing or sharing merchant's promotional material, by liking the merchant on user's social network site, by referring a friend or the like. Thus, the user may earn reward points by various non-payment activities. The system may consider these non-purchase activities that are likely to be perform by the user and may suggest loyalty programs accordingly. For example, if a loyalty program allows a user to earn reward points by checking in at a merchant's store and the merchant is opening a store near the user and the user is likely to visit the store frequently, the system may suggest the loyalty program or the merchant to the user accordingly.

At step 312, the system may present selected loyalty programs for the impending purchases to the user. In particular, information regarding the different loyalty programs may be displayed to the user 105 at user device 110. A list of loyalty programs may be displayed to the user 105 for the user's selection. The information may include the name of the loyalty program, type of rewards, reward points or reward mileages to be earned from the purchase, the purchase forecast, comparative reward values of the loyalty programs, other amenities or discounts of the loyalty programs, reason a loyalty program is selected, such as based on the user defined reward preferences or based on purchase forecast, and the like.

In an embodiment, the list of loyalty programs may be displayed to the user 105 in an order of overall reward values based on the user's purchase forecast. As noted above, based on the user's purchase forecasts for a month or a year, the overall reward values of various loyalty programs may be calculated or estimated. Thus, loyalty programs that have top overall reward values may be presented to the user 105 first.

In an embodiment, the list of loyalty programs may be displayed to the user 105 in an order of reward value to expense ratio. As noted above, a reward value per dollar spent may be calculated for each loyalty program. The loyalty programs that have top reward value per dollar spent may be presented first for the user 105's selection.

In an embodiment, the list of loyalty programs may be displayed to the user 105 in an order of progress to reward. For example, based on the reward points or mileages accumulated and the reward points or mileages needed for earning rewards, the system may present loyalty programs in which the user 105 is closest to earning rewards. For example, the user 105 may already have enough reward points in loyalty program A for a reward, may need 150 more reward points or mileage for earning a reward in loyalty program B, and may need 1000 more reward points or mileage for earning a reward in loyalty program C. The system may present loyalty program B first, because the use 105 is closest to earning a reward in loyalty program B. The system may present loyalty program C next, because it is second closest to earning a reward. The system may present loyalty program A last, because a reward already has been earned. Thus, loyalty programs may be suggested to help the user 105 earn rewards faster among different loyalty programs.

The system may display comments or reasons why a loyalty program is selected. For example, a loyalty program may be selected because it has the best overall reward value based on the user's purchase forecast. In another example, a loyalty program may be selected because it is closest to earning a reward and the impending purchase would allow the user to earn the reward. In still another example, a new loyalty program may be selected because the user can get 50% off of the entire impending purchase.

In an embodiment, the list of loyalty programs may be displayed to the user 105 based on the user 105's preference. For example, the user 105 may wish to view loyalty programs that improve the user 105's credit score first. In another example, the user 105 may wish to view his or her favorite or frequently used loyalty programs first, unless other loyalty programs provide substantial values to the user 105.

At step 314, the system may receive user 105's response or selection of loyalty programs. The user 105 may select one loyalty program. At step 316, the system may then process the impending purchase using the selected loyalty program. In an embodiment, the system may allow the user 105 to select two or more loyalty programs to be used for the impending purchase. For example, the user 105 may wish to split the reward points from the impending purchase for two different loyalty programs by paying with two different credit cards. In response to the multiple selections, the system may allow the user 105 to input how the impending purchase should be divided between two or more loyalty programs. For example, the user 105 may designate 30% of the purchase for loyalty program A and 70% of the purchase for loyalty program B. After the user 105's selection, the system may present the reward points or miles that will be earned by each selected loyalty programs to the user 105. At step 316, the system may then process the purchases or payments accordingly using the selected loyalty programs.

By using the above processes 200 and 300, the system may analyze the user's purchase history, browsing or search history, personal information, budget, and various information to determine the user's reward preferences, upcoming purchases, or spending preferences. The system may then suggest or recommend loyalty programs based on the user's reward preferences, upcoming purchases, or spending habits. When the user is about to make a purchase or is planning on making purchases, the system may suggest loyalty programs to the user to provide top reward values based on the user's reward preferences or spending habits. Thus, the system may automatically analyze and suggest loyalty programs to the user to manage the user's loyalty programs and to provide top reward values tailored to the user.

The above processes 200 and 300 may be implemented at the user device 110. In an embodiment, the above processes 200 and 300 may be implemented at the payment provider server 170 or the merchant device 140. In still another embodiment, the above processes 200 and 300 may be implemented by the user device 110, the payment provider server 170, and/or the merchant device 140 in coordination with each other. Note that the various steps described herein may be performed in a different order, combined, and/or omitted as desired.

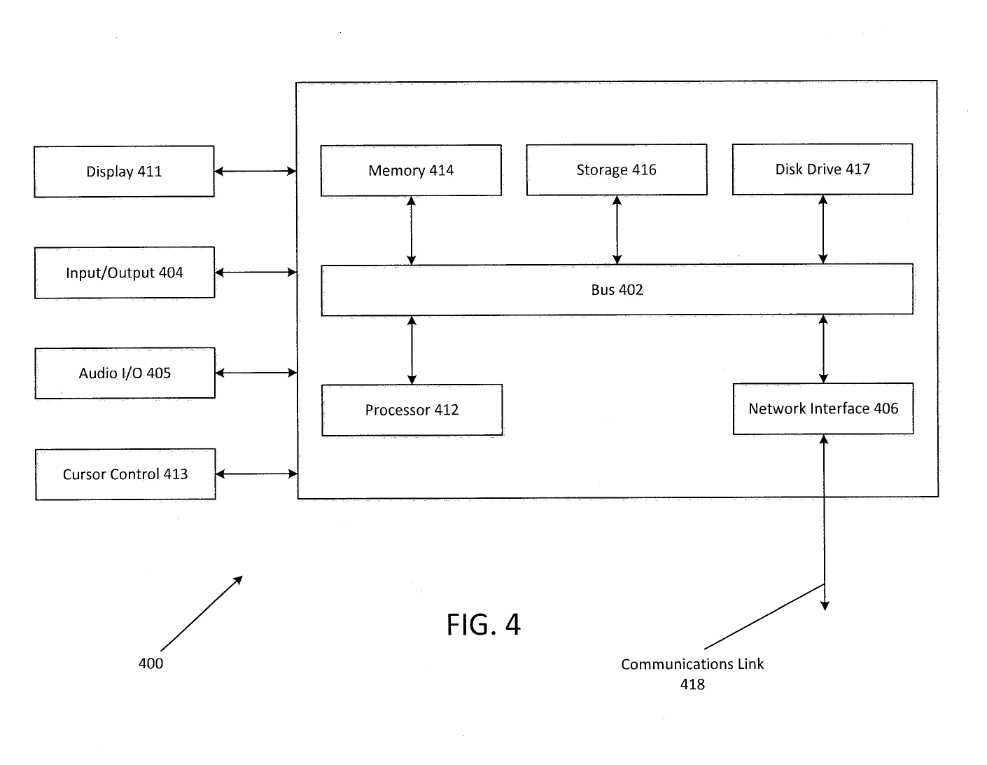

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 160. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a hardware memory storing a plurality of loyalty programs associated with a plurality of merchants; and
one or more processors in communication with the memory and adapted to:
determine an impending purchase of a user;
predict future purchases of the user;
select a particular loyalty program for the impending purchase from the plurality of loyalty programs based on the predicted future purchases of the user; and
present the particular loyalty program to the user for the impending purchase.

2. The system of claim 1, wherein the one or more processors are further adapted to:
determine an overall monetary reward value of each of the plurality of loyalty programs;
compare overall monetary reward values of the plurality of loyalty programs; and
select the particular loyalty program based on the overall monetary reward values calculated based on the predicted future purchases of the user.

3. The system of claim 2, wherein the overall monetary reward value is calculated by:
estimate an expense budget for the predicted future purchases; and
calculate a total monetary value of rewards earned by the expense budget in a loyalty program.

4. The system of claim 1, wherein the one or more processors are further adapted to:
determine an reward value to expense ratio of each of the plurality of loyalty programs for the predicted future purchases;
compare the reward value to expense ratios of the plurality of loyalty programs for the predicted future purchases; and
select the particular loyalty program based on the reward value to expense ratios determined for the predicted future purchases.

5. The system of claim 4, wherein the reward value to expense ratio is calculated by:
determine a monetary value of rewards offered by a loyalty program for the predicted future purchases;
determine expenses needed to earn the rewards; and
divide the monetary value of rewards by the expenses.

6. The system of claim 1, wherein the one or more processors are further adapted to:
compare how close each loyalty program is to earning a reward in view of the predicted future purchases; and
select the particular loyalty program based on how close the particular loyalty program is earning a reward in view of the predicted future purchases.

7. The system of claim 6, wherein the one or more processors are further adapted to:
determine a number of reward points or miles currently accumulated in a loyalty program; and
calculate a difference between the number of reward points or miles currently accumulated and a number of reward points or miles needed to earn a reward in the loyalty program.

8. The system of claim 1, wherein the impending purchase is a purchase forecast based on one or more of purchase history of the user, browsing history of the user, a to-do list of the user, a wish list of the user, a social network account of the user, a budget of the user, and a calendar of the user.

9. The system of claim 1, wherein the particular loyalty program is selected based on non-purchase activities that are eligible for earning rewards in the particular loyalty program.

10. The system of claim 1, wherein the impending purchase is determine based on a location of the user detected at a user device.

11. A method comprising:
determining, by a hardware processor, an impending purchase by a user;
predicting, by the hardware processor, future purchases of the user;
selecting, by the hardware processor, a particular loyalty program based on the predicted future purchases of the user from a plurality of loyalty programs; and
presenting, by the hardware processor, the particular loyalty program to the user for the impending purchase.

12. The method of claim 11, wherein the predicted future purchases are based on one or more of purchase history of the user, browsing history of the user, a to-do list of the user, a wish list of the user, a social network account of the user, a budget of the user, and a calendar of the user.

13. The method of claim 12, wherein the predicted future purchases are determined based on the user's input via a survey or a questionnaire.

14. The method of claim 11 further comprising:
determining types or categories of rewards offered by each of the plurality of loyalty programs; and
selecting the particular loyalty program based on a type or category of rewards that matches reward preferences of the user.

15. The method of claim 11 further comprising:
determining prices of the impending purchase offered at merchants;
determining reward values offered by loyalty programs associated with the merchants and earnable by the predicted future purchases of the user; and
selecting the particular loyalty program by comparing the prices of the impending purchase offered at the merchants and the reward values earnable by the predicted future purchase of the user at the associated loyalty programs.

16. The method of claim 11 further comprising:
determining market values of rewards offered by each of the plurality of loyalty programs and earnable by the predicted future purchases; and
selecting the particular loyalty program that offers based on the market values of rewards earnable by the predicted future purchases.

17. The method of claim 11 further comprising:
determining expirations of reward points or miles accumulated by the user in each of the plurality of loyalty programs; and
selecting the particular loyalty program that has reward points or miles that are closest to expiration and that are usable based on the predicted future purchases.

18. The method of claim 11 further comprising:
determining a credit score of the user; and
selecting one or more loyalty programs that improve the credit score of the user.

19. A non-transitory machine-readable medium comprising a plurality of machine-readable instructions which when executed by one or more processors are adapted to cause the one or more processors to perform a method comprising:
determining an impending purchase by a user;
predicting future purchases of the user;
selecting a particular loyalty program based on the predicted future purchases of the user from a plurality of loyalty programs; and
presenting the particular loyalty program to the user for the impending purchase.

20. The non-transitory machine-readable medium of claim 18, wherein the method further comprising determining the predicted future purchases based on one or more of purchase history of the user, browsing history of the user, a to-do list of the user, a wish list of the user, a social network account of the user, a budget of the user, and a calendar of the user.
